(19) United States
(12) Patent Application Publication
(10) Pub. No.: US 2011/0183229 A1
(43) Pub. Date: Jul. 28, 2011

(54) FUEL CELL ARRANGEMENT COMPRISING FUEL CELL STACKS

(76) Inventors: Erkko Fontell, Espoo (FI); Timo Mahlanen, Helsinki (FI); Petri Hossi, Kauniainen (FI); Peik Jansson, Espoo (FI)

(21) Appl. No.: 13/122,052

(22) PCT Filed: Oct. 15, 2009
(86) PCT No.: PCT/FI09/50828

§ 371 Date: Mar. 31, 2011

(30) Foreign Application Priority Data
Oct. 17, 2008 (FI) 20085976

(51) Int. Cl. H01M 8/24; H01M 8/04

(52) U.S. Cl. 429/458

(57) ABSTRACT

A fuel cell arrangement comprising a number of fuel cell stacks (17, 17′) consisting of planar fuel cells, the stacks being arranged one after the other, each of which being provided with a gas connection for the inlet and outlet flows of the gas of the anode and the cathode side. The fuel cell stacks (17, 17′) are arranged as a tower on a fastening plane element (2, 2′) acting as a load-bearing structure, the tower being supported by means of an end piece (19, 19′) arranged at the end opposite to the fastening plane element (2, 2′) of the tower and by tie bars (11, 11′) connecting the fastening plane element and the end piece. The fastening plane element (2, 2′) is provided with inlet and exhaust flow channels for both anode and cathode side gas, the channels being connected to the common anode and cathode side gas tubes (6, 6′; 7, 7′) of the tower arranged in connection with the tower for arranging the gas connection of the fuel cell stacks.

The present invention relates to a fuel cell arrangement according to the preamble of claim 1 comprising a number of fuel cell stacks formed by planar fuel cells, the stacks being arranged one after the other, each being provided with a gas connection for the inlet and exhaust flows of the gas of the anode and the cathode side.

Electric energy can be produced by means of fuel cells by releasing electrons by oxidizing fuel gas on the anode side and to further combine the electrons on the cathode side by reducing oxygen or by using other reducing agent subsequent to the electrons having passed through an external circuit producing work. In order to produce the action each fuel cell must be provided with fuel and oxygen or other reducing agent. Usually this is effected by providing a flow of fuel and air to the anode and cathode sides. Typically, the potential difference produced by a single fuel cell is, however, so small that in practice a fuel cell unit, i.e. a stack, is produced from a number of fuel cells by connecting a number of cells electrically in series. Separate units can then be further connected in series for increasing the voltage. Each fuel cell unit, i.e. a fuel cell stack must be provided with the substances needed for the reaction, fuel and oxygen (air). The reaction products must correspondingly be transported away from the units. This necessitates a gas flow system for accomplishing gas flows for both the cathode and anode sides. In practice, in a fuel cell plant, fuel cell stacks must be connected in series for providing sufficient electric power and to further connect in parallel such assemblies connected in series. It is thus obvious that forming both the connections for electric flows and gas flows will be problematic.

U.S. Pat. No. 6,692,859B2 discloses one solution for realizing the gas flows of fuel cell stacks. This kind of solution produces a solution with a non-optimal space usage in case the arrangement is to be one of higher power.

The object of the invention is to produce a fuel cell arrangement that is easy to install and service and in which the design of the gas flow system of the fuel cell stacks is as simple, durable and optimal in space usage as possible.

The object of the invention can be achieved as described in claim 1 and as disclosed in more detail in other claims. In a fuel cell arrangement according to the invention the fuel cell stacks are arranged as a tower on a fastening plane element acting as a load-bearing element, the tower being supported by means of an end piece arranged at the end opposite to the fastening plane element of the tower and by tie bars connecting the fastening plane element and the end piece. The fastening plane element is provided with inlet and exhaust flow channels for both the anode and cathode side gases, the channels being connected to common anode and cathode side gas tubes of the tower arranged in connection with the tower for arranging the gas connection of the fuel cell stacks. The tower structure and introduction of gas via a fastening plane element simultaneously acting as a support structure is advantageous for achieving a fuel cell arrangement with advantageous use of space and production of energy.

An advantageous solution for assembling the tower and creating its gas flows is achieved if the gas tubes are connected to the conduits of the anode and cathode side of the fuel cell stacks via separate inlet and collector pieces so that a fuel cell stack is arranged on both sides of each inlet and collector piece. Thus, the inlet and collector pieces preferably comprise an inlet and exhaust channel arrangement for the anode side gas flow and an inlet and exhaust channel arrangement for the cathode side gas flow, both being correspondingly connected to the anode and cathode side of the fuel cell stack connected to both inlet and collector pieces and to corresponding common gas tubes of the tower.

The channel arrangements of the inlet and collector pieces are arranged so that the ends of the fuel cell stacks located on both sides of the inlet and collector pieces against it are terminals having the same potential. This has the advantage that the electric insulation between the stacks is easy to arrange due to the minimal potential difference.

The inlet and collector pieces are also preferably supported by the said tie bars. For this purpose the inlet and collector pieces are provided with holes for the tie bars. The said holes for the tie bars are provided with an insulator acting as an electric insulation between the tie bar and the inlet and collector piece. This allows the tie bars and further the fastening substrate to be electrically insulated from the fuel cell stacks.

Preferably the arrangement comprises two or more pairs of two consecutive fuel cell stacks connected by means of an inlet and collector piece formed as a tower one on top the other. Thus the surface area needed by the fuel cells can be minimized by increasing the height of the towers.

For introducing the gas flows and supporting the tower it is preferable that the cross-sectional area of the inlet and collector pieces is larger across the tower than the area of the fuel cell stacks. Thus the inlet and collector pieces can easily be connected to each other through the said gas tubes as well, the gas tubes being located outside the fuel cell stacks.

In a practical preferred embodiment the gas tubes are provided with a bellows installed between each inlet and collector piece. The gas tubes additionally consist of channel pieces arranged between two inlet and collector pieces located one after the other.

Preferably there also is an electric insulation between the fuel cell tower and the fastening plane element.

The arrangement preferably comprises a number of towers formed by fuel cell stacks and fastened to the same fastening plane element comprising the anode and cathode side gas flow channels, which are arranged to be connected to the anode and cathode side conduits of each fuel cell tower. This produces a compact solution also allowing production of larger power levels.

In the following, the invention is described as an example with reference to the appended schematic drawings, in which

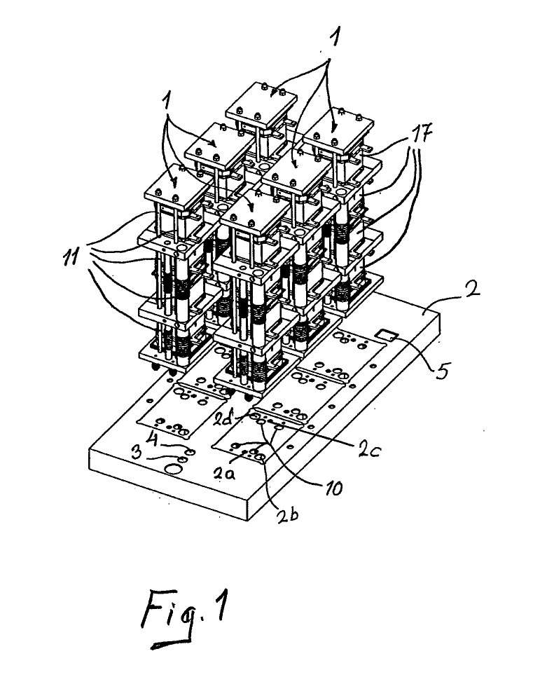

FIG. 1 is a principle drawing of one embodiment of a fuel cell arrangement according to the invention in which a number of fuel cell stacks are assembled as towers which can be installed on a common fastening plane element,

FIG. 2 illustrates the fuel cell arrangement of FIG. 1 seen obliquely from below,

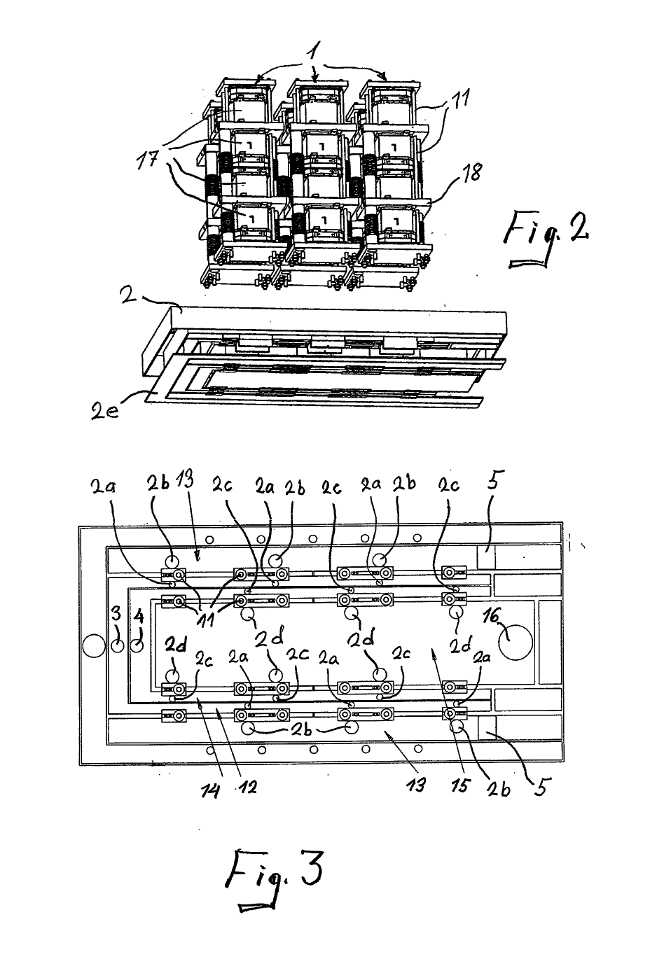

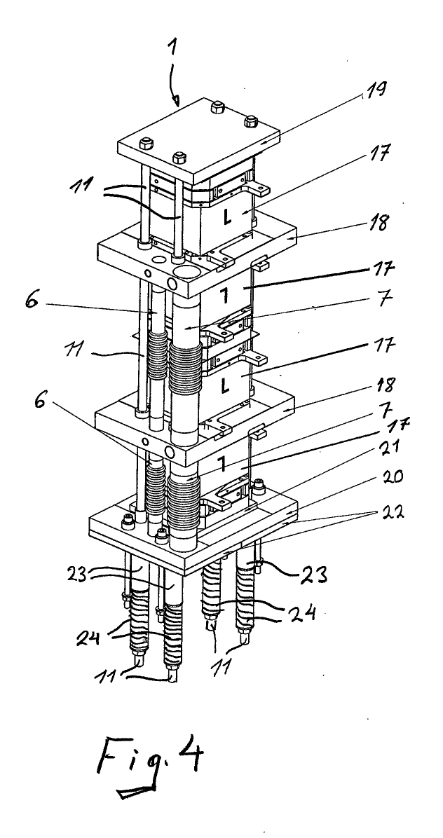

FIG. 3 shows the fastening plane element of FIGS. 1 and 2 opened and seen directly from below,

FIG. 4 illustrates a fuel cell tower consisting of fuel cell stacks according to the fuel cell arrangement of FIGS. 1 and 2,

FIG. 5 illustrates an embodiment of an inlet and collector piece included in a fuel cell arrangement of FIG. 4.

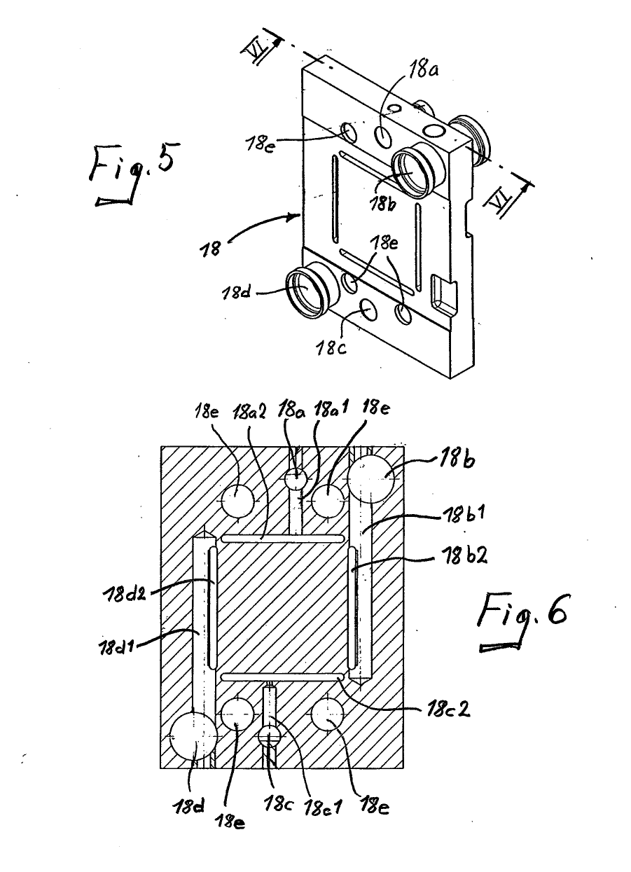

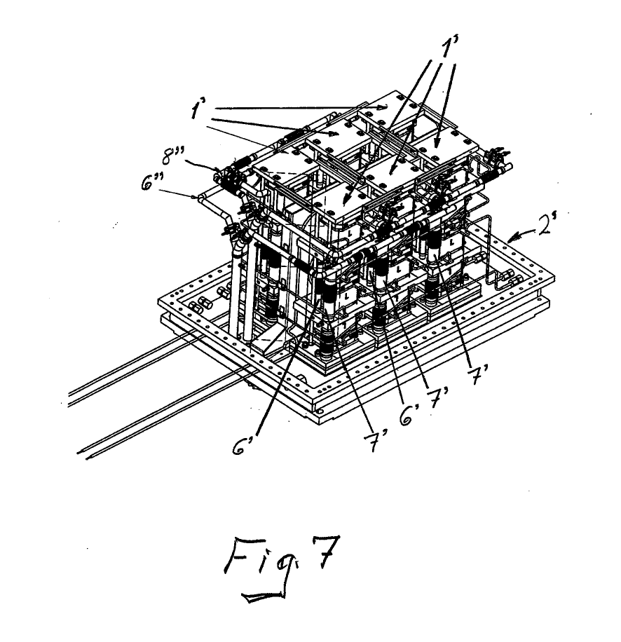

FIG. 6 illustrates section VI-VI of FIG. 5.

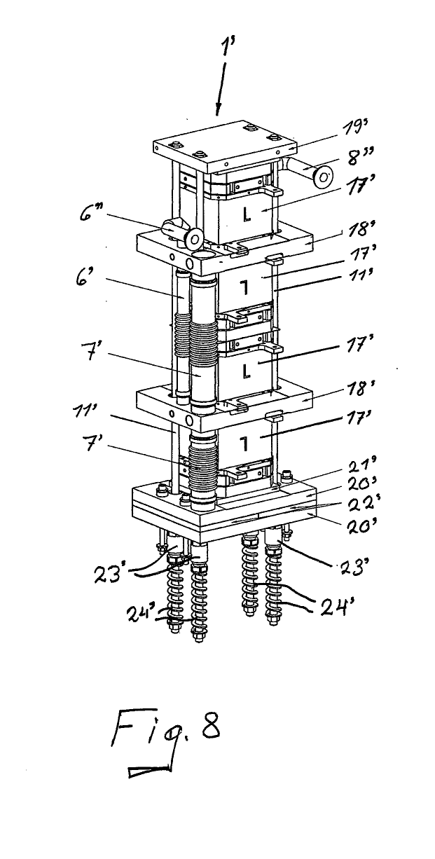

FIG. 7 is a principle illustration of one embodiment of a fuel cell arrangement according to the invention in which a number of fuel cell stacks are assembled as towers which can be installed on a common fastening plane element,

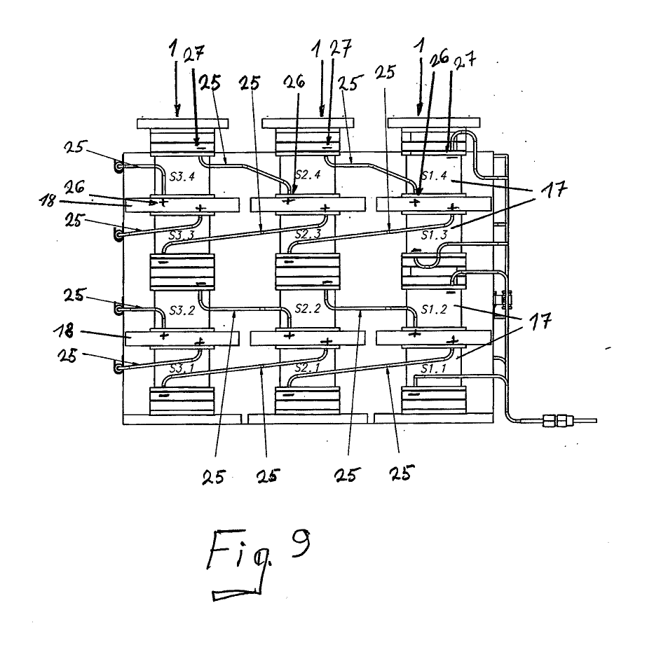

FIG. 8 illustrates a fuel cell tower consisting of fuel cell stacks according to the fuel cell arrangement of FIG. 7,

FIG. 9 illustrates the electric wiring principle of a fuel cell arrangement comprising a number of fuel cell towers.

FIGS. 1 and 2 illustrate the principle of a fuel cell arrangement formed by fuel cell stacks 17 comprising planar fuel cells, the stacks being formed into fuel cell towers 1. The fuel cell towers 1 are arranged onto a common fastening plane element 2 by using tie bars 11 screwed into the fastening plane element 2. In this embodiment all anode and cathode side gas flows are arranged via the fastening plane element 2, whereby the amount of difficult tube pass-throughs can be minimized. For this purpose the fastening plane element 2 is provided with an opening 3 for introducing fuel, opening 4 for exhausting the fuel side reaction products, opening 5 for introducing air and opening 16 for directing spent air away from the fastening plane element 2. The fastening plane element further comprises openings for directing corresponding gas flows to the fuel cell towers and back from there via the fastening plane element.

As can be seen in FIGS. 1 and 3, the fastening plane element 2 has for each fuel cell tower 1 openings 2a for introducing fuel, openings 2b for introducing air, openings 2c for the fuel side exhaust and openings 2d for exhausting the air. The gas flows are directed in the fastening plane element 2 via common channels 12 (fuel inlet), 13 (air inlet), 14 (fuel side exhaust) and 15 (air exhaust) connecting the different fuel cell towers 1 (see FIGS. 2 and 3). The channels stay between the fastening plane element 2 and its bottom plate 2e. The fastening plane element 2 is additionally provided with openings 10 for passing the tie bars 11 through them.

FIG. 4 illustrates a single fuel cell tower 1 comprising a number of fuel cell stacks 17 arranged in pairs so that there is an inlet and collector piece 18 between two fuel cell stacks 17. The anode and cathode side gas flows are accomplished via the fastening plane element 2 by using gas tubes arranged outside the tower, of which the fuel inlet tube 6 and the air inlet tube 7 are shown in FIG. 4. The fuel side exhaust tube and the air outlet tube, not shown in FIG. 4, are located symmetrically with the fuel cell tower 1, on the opposite side. All these gas tubes are connected to the fuel cell stacks 17 via the inlet and collector pieces 18 extending across the tower beyond the actual fuel cell stacks 17.

The fuel cell stacks 17 and inlet and collector pieces 18 of the fuel cell tower 1 are supported by tie bars 11 arranged on the edges of the tower, the tie bars keeping the tower together by means of end pieces 19 and 20. The tie bars 11 are tightly insulated from the channels of the fastening plane 2 by means of insulators 23. The tie bars 11 are arranged to extend in their longitudinal direction freely through the inlet and collector pieces 18, whereby the arrangement is fully floating on that part. The tie bars 11 are also insulated from the inlet and collector pieces 18 by means of, e.g. sleeves (c.f. FIG. 4). By means of the insulator sleeves the tie bars 11 and inlet and collector pieces 18 can be electrically insulated from each other and be thus kept in different potentials. Correspondingly it is possible to use with advantage an insulation sleeve (not shown in detail) at the attachment point of the tie bars in the end piece 19 as well and thus it is also possible to keep the end piece 19 in a different potential than the tie bars 11.

The tie bars are additionally provided with a tightening arrangement which in the solution of the figure comprises springs 24 and the tightening nuts connected therewith. Because of this the gas tubes are in practice assembled from tube parts between the inlet and collector pieces 18 and the fastening plane assembly 2, provided with bellows as shown in FIG. 4. The fuel cell tower 1 is separately fastened to the fastening plane element 2 by means of end piece 20 with screw bolts. The end piece 20 is insulated from the actual tower and the fastening plane element by means of insulators 21 and 22.

When using the fuel cell arrangement produced by means of the invention, which is particularly a high-temperature arrangement, as arrangements based on solid oxide fuel cell are, there are considerable temperature changes in the parts of the arrangement during different operation phases. The arrangement according to the invention allows very good control of thermal expansion. While the long tie bars 11 and the tightening arrangement having springs 24 provide sufficient compression power, the floating connection of the inlet and collector pieces 18, on the other hand, allows an even compression power in various connections while eliminating the forming of excessive tensions. Further, the arrangements according to the invention allow an efficient insulation of the production of electricity of the fuel cell tower from the fastening plane element.

FIGS. 5 and 6 illustrate one practical embodiment of the design of the inlet and collector piece 18. Anode gas is introduced via channel 18a which is in connection with the inlet tube 6 (not shown here, see FIG. 4), whereby the connection with the fuel cell stack is arranged via channels 18a1 and 18a2 so that it is carried out using the whole corresponding side surface of the fuel cell stack. The exhaust is accordingly carried out via channels 18c1 and 18c2 which are in connection with the exhaust channel 18c and therethrough further to the exhaust tube (not shown here). Cathode gas is correspondingly introduced via channel 18b which is in connection with the inlet tube 7 (not shown here, see FIG. 4), whereby the connection with the fuel cell stack is arranged via channels 18b1 and 18b2 so that it is also carried out using the whole corresponding side surface of the fuel cell stack. The exhaust is accordingly carried out via channels 18d1 and 18d2 which are in connection with the exhaust channel 18d and therethrough further to the exhaust tube (not shown here). The openings 18e are for passing the tie bars 11 therethrough. All inlet and collector pieces 18 of the fuel cell stack can be similar in design. FIG. 5 also shows using insulator sleeves in connection with the flow tubes. Here the insulator sleeves are shown only as examples in connection with channels 18b and 18d.

As can be seen in FIGS. 5 and 6, some of the inlet and exhaust channels, here the anode side channels having the smallest diameter, are arranged in the centre portion of the section level of the fuel cell stack so as to be advantageous for the usage of space. If desired, other kinds of arrangements can also be used, for example so that all gas tubes are arranged in the corners of the fuel cell stack.

FIG. 7 is a principle drawing of one embodiment of a fuel cell arrangement according to the invention in which a number of fuel cell stacks are assembled as fuel cell towers 1′ installed on a common fastening plane element 2′. This embodiment differs from the embodiment of FIG. 1 in that only inlet of air into the tower (tubes 7′) and from there (not shown in detail in the figure) are carried out directly between the fastening plane element 2′ and the tower. The inlet and exhaust of fuel are also realized via the fastening plane element 2′, but not in a direct connection to towers 1′ and their vertical flow tubes, but via separate distribution tubings 6′ and 8′. The inlet and exhaust flows to the fastening plane element 2′ and away from there are carried out below the fastening plane element 2′ or at its sides (not shown in detail). Further, in practice the whole fuel cell arrangement of FIGS. 1 and 7 are enveloped by a gas-tight insulator casing.

FIG. 8 illustrates a single fuel cell tower 1′ consisting of fuel cell stacks according to the fuel cell arrangement of FIG. 7. The design is analogous with that of the fuel cell tower 1 of FIG. 4 with the exception of the inlet and outlet of fuel which are carried out from above via tubes 6″ and 8″. Due to this, the fuel flow tubes connected to the inlet and collector pieces 18′ do not directly extend to the fastening plane element 2′.

FIG. 9 shows the principle of electrical connections between a number of fuel cell towers. According to the invention each fuel cell stack 17 has its own ordinal number from the fastening plane element so that closest to the fastening plane element is the first fuel cell stack 17, next is the second one and so on. The electric connection is carried out by connecting the fuel cell stacks 17 having the same number in series with each other with conductors 25. This is accomplished by connecting the terminals 26, 27 having different potentials to each other. Because the ordinal number of the stack from the fastening plane also has an effect to the distance from the fastening plane, the distance, i.e. height difference, also causes temperature difference between various distances. Because the temperature of a fuel cell has an effect on the operation of the fuel cell, the above-mentioned connection produces the advantage that the same electric serial connection has fuel cell stacks 17 operating in the same temperature, whereby their electricity production is as close to each other as possible.

The fuel cell stacks 17 are electrically conductive and they are designed so that their terminals 26, 27 are in the opposite ends of the stack. The fuel cells are further arranged so that the terminals having the same potential are always in the same end as the inlet and collector piece 18 of the fuel cell stack. Thus the fuel cell stacks 17 of the fuel cell tower are according to the invention so that the ends having the same potential are facing each other. This produces the advantage that the potential difference over the inlet and collector piece 18 stays relatively small, whereby the electric insulation between the inlet and collector piece 18 and the fuel cell stack 17 does not, correspondingly, have to be very effectively insulating. Correspondingly, the insulation between the two fuel cell stacks 17 does not have to be very effectively insulating, as these ends also have the terminal 27 for the same potential.

As can be seen especially in FIGS. 4, 8 and 9, in a fuel cell stack 1,1′ adaptor plates are used between the fuel cell stacks 17, 17′ arranged one on top of each other for smoothing any irregularities of the level surfaces of the fuel cell stacks.

The invention is not limited to the disclosed embodiments, but several modifications thereof can be conceived of within the appended claims.

1. A fuel cell arrangement comprising a number of fuel cell stacks formed by planar fuel cells, the stacks being arranged one after the other and each being provided with a gas connection for the inlet and exhaust flows of the gas of the anode and cathode side, wherein the fuel cell stacks are arranged over a fastening plane element acting as a load-bearing structure as a tower supported by an end piece arranged at the end opposite to the fastening plane element and by tie bars connecting the fastening plane element and the end piece and that the fastening plane element is provided with inlet and exhaust flow channels for both anode and cathode side, the channels being connected to common gas tubes of the tower arranged in connection with the tower for providing gas connection to the fuel cell stacks.

2. The fuel cell arrangement according to claim 1, wherein the gas tubes are connected via separate inlet and collector pieces to the conduits of the anode and cathode side of the fuel cell stacks so that a fuel cell stack is provided on both sides of each inlet and collector piece and that the inlet and collector pieces comprise an anode side gas flow inlet and exhaust channel arrangement and a cathode side gas flow inlet and exhaust channel arrangement which are correspondingly connected to the anode and cathode side of the fuel cell stack connected to each inlet and collector piece and to corresponding common gas tubes of the tower.

3. The fuel cell arrangement according to claim 2, wherein the channel arrangements of inlet and collector pieces are arranged so that the ends of the fuel cell stacks located on both sides of the inlet and collector piece against it are terminals having the same potential.

4. The fuel cell arrangement according to claim 2, wherein the inlet and collector pieces are supported to the said tie bars.

5. The fuel cell arrangement according to claim 4, wherein the inlet and collector pieces are provided with pass-throughs for the tie bars and the pass-throughs are provided with an insulator acting as electric insulation between the tie bar and the inlet and collector piece.

6. The fuel cell arrangement according to claim 2, wherein the arrangement comprises two or more pairs of fuel cell stacks connected by means of the inlet and collector piece one on top the other formed into a tower.

7. The fuel cell arrangement according to claim 2, wherein the cross-sectional area of the inlet and collector pieces across the fuel cell tower is larger than the area of the fuel cell stacks and the inlet and collector pieces are connected to each other via the said gas tubes, the gas tubes being located outside the fuel cell stacks.

8. The fuel cell arrangement according to claim 7, wherein the gas tubes are provided with a bellows installed between each inlet and collector piece.

9. The fuel cell arrangement according to claim 7, wherein the gas tubes consist of channel pieces arranged between two consecutive inlet and collector pieces.

10. The fuel cell arrangement according to claim 1, wherein an electric insulation is provided between the fuel cell tower and the fastening plane element.

11. The fuel cell arrangement according to claim 1, wherein the arrangement comprises a number of fuel cell towers formed by fuel cell stacks, the towers being attached to the same fastening plane element comprising anode and cathode side gas flow channels arranged to be connected to the anode and cathode side conduits of each fuel cell tower.
